(19) United States
(12) Patent Application Publication
(10) Pub. No.: US 2025/0183361 A1
(43) Pub. Date: Jun. 5, 2025

(54) LITHIUM-DEFICIENT AND HALIDE-RICH SOLID ELECTROLYTES

(71) Applicants: Umicore, Brussels (BE); Centre National De La Recherche Scientifique, PARIS (FR); UNIVERSITE DE PICARDIE JULES VERNE, Amiens (FR)

(72) Inventors: Jérémie AUVERGNIOT, Grenoble (FR); Solveig KJELDGAARD, Arendal (NO); Christian MASQUELIER, Amiens (FR); Virginie VIALLET, Amiens (FR); Dhanush SHANBHAG, Paris (FR)

(21) Appl. No.: 18/876,805

(22) PCT Filed: Jun. 20, 2023
(86) PCT No.: PCT/EP2023/066627

§ 371 Date: Dec. 19, 2024

(30) Foreign Application Priority Data
Jun. 24, 2022 (EP) 22290042.5

(51) Int. Cl. H01M 10/0562; H01M 10/058

(52) U.S. Cl. CPC H01M 10/0562; H01M 10/058; H01M 2300/008

(57) ABSTRACT

The present invention relates to lithium-deficient and halide-rich solid electrolytes. These solid electrolytes display an increased ionic conductivity.

### TECHNICAL FIELD AND BACKGROUND

This invention relates to a solid electrolyte being lithium-deficient and halide-rich, a method for manufacturing said solid electrolyte and a battery comprising said solid electrolyte.

As the development of small and lightweight electronic products, electronic devices, communication devices and the like has advanced rapidly and a need for electric vehicles has widely emerged with respect to environmental issues, there is a demand for improvement of performance of secondary batteries used as power sources for these products. Among these, a lithium secondary battery has come into the spotlight as a high-performance battery due to a high energy density and a high reference electrode potential.

However, electrolytes conventionally used in lithium secondary batteries are liquid electrolytes made with lithium salts dissolved in organic solvents. Accordingly, safety problems such as leakage of electrolytes and risk of fire may continuously occur.

Recently, solid state batteries including solid electrolytes, rather than liquid electrolytes have been used to improve the safety feature of the lithium secondary battery and have attracted much attention. For example, solid electrolytes are typically safer than liquid electrolytes due to non-combustible or flame retardant properties.

Solid electrolytes may include oxide-based solid electrolytes, polymer-based electrolytes and sulfide-based electrolytes. Sulfide-based electrolytes have been generally used due to their higher lithium ionic conductivity range compared to oxide-based and polymer-based solid electrolytes, such as sulfide-based solid electrolytes having an argyrodite-type crystal structure.

WO2020/033809 A1 and Patel et al (Chem. Mater. 2021, 33, 4, 1435-1443) describe the synthesis of lithium-deficient halide-rich solid electrolytes having general formula Li_{6-ω}PS_{5-ω}Cl_{1.0}Br_{ω} with 0≤ω≤0.7, such as Li_{5.7}PS_{4.7}Cl_{1.0}Br_{0.3} and Li_{5.5}PS_{4.5}Cl_{1.0}Br_{0.5.}

It is an object of the present invention to provide a lithium-deficient and halide-rich solid electrolyte.

It is a further object of the present invention to provide a method for manufacturing said solid electrolyte.

It is a further object of the present invention to provide a battery comprising said solid electrolyte.

### SUMMARY OF THE INVENTION

In a first aspect an object of the present invention is achieved by providing a solid electrolyte having a composition according to formula (I)

Li_{6-y}PS_{5-y}BrX_{y} (I)

, wherein 0.0<y<0.8 and X is F, Cl, I or a combination thereof.

The present inventors have surprisingly found that these lithium-deficient halide-rich solid electrolyte compositions display an increased ionic conductivity up to 9.9 mS·cm⁻¹, as demonstrated in the appended examples. In particular, high conductivities are measured even at low temperatures, making these compositions suitable for low-temperature applications. Moreover, these solid electrolyte compositions according to the invention display a reduced H₂S gas evolution upon contact with moisture making them more attractive for commercial production and use in batteries.

Without wishing to be bound by any theory the present inventors believe that X⁻/S²⁻ site disorder is increased by the excess and/or mixed halide substitution thereby affecting the lithium substructure by modifying Li⁺ site locations due to the electrostatic difference between S²⁻ and X⁻. Moreover, when sulfide electrolytes containing PS₄ tetrahedra react with moisture, sulfur in PS₄ is replaced by oxygen thereby generating H₂S gas. This poor moisture stability of known argyrodites, such as Li₆PS₅Br and Li₆PS₅Cl, can be mainly attributed to the oxophilicity nature of phosphorous. However, substitution of S²⁻ in the composition with a halide, results in a decrease in H₂S evolution as demonstrated in the appended examples.

In a further aspect the invention provides a method for manufacturing said solid electrolyte.

The inventors have surprisingly found that the electrolyte precursor mixture containing stoichiometric ratios of Li₂S, P₂S₅, LiBr and LiCl needs to be ball-milled for at least 0.5 hour. WO2020/033809 A1 teaches that the disclosed solid electrolyte compositions, such as Li_{5.7}PS_{4.7}Cl_{1.0}Br_{0.3} and Li_{5.7}PS_{4.7}Cl_{1.0}I_{0.3}, are obtained after ball-milling for 10 minutes. However, these ball-milling conditions, in particular the ball-milling time of the solid electrolyte precursor, are not sufficient enough to obtain the solid electrolyte compositions according to the invention.

In a further aspect the invention provides the battery comprising the solid electrolyte according to the invention.

### BRIEF DESCRIPTION OF THE FIGURES

FIG. 1a: X-ray diffraction patterns of Li₆₋ₓPS₅₋ₓBr_{1.0}Clₓ with nominal x=0, 0.1, 0.3, 0.5, 0.7 and 0.8, recorded at 298 K in a Beryllium-capped tight cell.

FIG. 1b: Enlarged region of Li₆₋ₓPS₅₋ₓBr_{1.0}Clₓ with nominal x=0.0, 0.1, 0.3, 0.5, 0.7 and 0.8 between 2θ=43° to 48°.

FIG. 2: X-ray diffraction patterns of Li_{5.5}PS_{4.5}Br_{1.5-x}Clₓ (x=0, 0.5, 1.0, 1.5) recorded at 298 K after annealing at 450° C.

FIG. 3: Variation of lattice constant a with increasing x in Li₆₋ₓPS₅₋ₓBr_{1.0}Clₓ with x=0, 0.1, 0.2, 0.3, 0.4, 0.5, 0.6, 0.7 and 0.8.

FIG. 4a: Raman spectra of Li₆₋ₓPS₅₋ₓBrClₓ (x=0.0, 0.1, 0.3, 0.5, 0.7 and 0.8) FIG. 4b: detailed Raman spectra of Li₆₋ₓPS₅₋ₓBrClₓ (x=0.0, 0.1, 0.3, 0.5, 0.7 and 0.8) between 360 and 480 cm⁻¹.

FIG. 5: H₂S generated per liter of air and gram of Li₆PS₅Br, Li₆PS₅Cl, Li_{5.3}PS_{4.3}BrCl_{0.7}, Li_{5.5}PS_{4.5}BrCl_{0.5} and Li_{5.7}PS_{4.7}BrCl_{0.3}.

FIG. 6: Rate capability for EX8 and CEX6.

FIG. 7: Long cycling stability cycled at C/5 for battery comprising a cathode composite with 60 wt. %, 70 wt. %, 80 wt. % and 88 wt. % NMC 622.

### DETAILED DESCRIPTION

In the drawings and the following detailed description, preferred embodiments are described in detail to enable practice of the invention. Although the invention is described with reference to these specific preferred embodiments, it will be understood that the invention is not limited to these preferred embodiments. To the contrary, the invention includes numerous alternatives, modifications and equivalents as will become apparent from consideration of the following detailed description and accompanying drawings.

The term “comprising”, as used herein and in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising components A and B” should not be limited to compositions consisting only of components A and B. It means that with respect to the present invention, the only relevant components of the composition are A and B. Accordingly, the terms “comprising” and “including” encompass the more restrictive terms “consisting essentially of” and “consisting of”.

The term “solid-state battery” as used herein refers to a cell or a battery that includes only solid or substantially solid-state components such as solid electrodes (e.g. anode and cathode) and solid electrolyte.

The term “argyrodite-type crystal structure” as used herein refers to a crystal structure having a crystal structure or system similar to naturally existing Ag₈GeS₆ and Li₇S₆ (Argyrodite). The argyrodite-type crystal structure may be of orthorhombic symmetry but more likely of cubic symmetry and described in the F-43m space group.

In some embodiments the argyrodite-type crystal structure may also be empirically determined for example, by X-ray diffraction by observing diffraction peaks around at 2θ=15.5±1°, 18±1°, 26±1°, 30.5±1° and 32±1° using the CuKα-ray wavelength.

X-Ray diffraction (XRD) as referred to herein, refers to XRD experiments performed using Bruker D8 diffractometers equipped with either Cu (Kα1-Kα2) or Mo (Kα1-Kα2) radiation in a θ-θ configuration.

Preferably, an air-tight sample holder capped with a Be window (mostly transparent to X-rays) is used. Preferably, the patterns were collected between 2θ=10°-70° with a step size of 0.02°.

Raman spectroscopy as referred to herein, refers to Raman experiments performed using a Raman DXR Microscope (Thermo Fischer Scientific) equipped with a green laser of excitation wavelength of 532 nm. Preferably, laser power of 0.1 mW was used to avoid sample damage due to excessive local heating. Preferably, spectra were collected by 1 second exposure time and 180 exposures.

Ionic conductivity as referred to herein, refers to the ionic conductivity determined at 25° C., unless described otherwise. It is preferably determined on cold-pressed samples in a 10 mm die at 625 MPa with a BioLogic CESH cell and spectra were recorded using MTZ 35 frequency response analyzer by applying 50 mV AC perturbation in the frequency range from 30 MHz to 1 Hz. Preferably, the relative density of the pellet was 85 to 87% and the thickness was 1.4 mm approximately. Preferably, indium foils were pressed on the surface of pellets as ion-blocking electrodes. More preferably, spectra were collected between the temperature of range of −20 to 50° C. with 10° C. intervals in the ITS temperature controller.

Moisture stability as referred to herein, refers to measuring the amount of H₂S recorded in ppm every 20 seconds for 20 minutes with a H₂S sensor (model-INS—H₂S-03 (0-400 ppm, 20-90% RH)). Preferably, approximately 45 mg of powder was pelletized in 10 mm die and the pellet was placed on a rectangular polymer container in a desiccator, and the lid of the desiccator was closed. The number of moles of H₂S generated per liter of ambient air and gram of sample were calculated using the following equation:

$$\frac{1 {ppm}_{H 2 S} * {MM}_{sample}}{{m}_{sample} * 24.79} = \frac{{mol}_{H 2 S} * {10}^{- 5}}{1 {Liter}_{air} * 1 {mol}_{sample}}$$

As appreciated by the skilled person, the composition according to formula (I), in particular the bromine content present in the composition according to formula (I) has the following stoichiometric ratio:

Li_{6-y}PS_{5-y}BrX_{y}(I)=Li_{6-y}PS_{5-y}Br_{1.0}X_{y} (I)′

The term “solid electrolyte precursor mixture” as used herein refers to an electrolyte precursor mixture being essentially free of any liquid. The term “essentially free of liquid” means that the solid electrolyte precursor mixture comprises less than 10 wt. % of a liquid by total weight of the solid electrolyte precursor mixture, preferably less than 7.5 wt. %, more preferably less than 5 wt. %, even more preferably less than 2.5 wt. %, most preferably less than 1 wt. % by total weight of the solid electrolyte precursor mixture. In a more preferred embodiment the solid electrolyte precursor mixture comprises less than 1000 ppm of a liquid by total weight of the solid electrolyte precursor mixture, preferably less than 500 ppm, more preferably less than 100 ppm, even more preferably less than 50 ppm, most preferably less than 10 ppm by total weight of the solid electrolyte precursor mixture.

In the context of the present invention a liquid shall be considered to be an organic or aqueous compound which is liquid in standard conditions for temperature and pressure as defined by the IUPAC. Hereby the boiling point and the melting point shall be considered to be the boiling point and the melting point at standard atmospheric pressure, i.e. at 101325 Pa. As appreciated by the skilled person the presence of the organic liquid can be determined via thermogravimetric analysis (TGA) or nuclear magnetic resonance (NMR) spectroscopy and the presence of the aqueous liquid can be determined via Karl Fisher titration.

The term “solid electrolyte mixture” as used herein refers to an electrolyte mixture being essentially free of any liquid. The term “essentially free of liquid” means that the solid electrolyte mixture comprises less than 10 wt. % of a liquid by total weight of the solid electrolyte mixture, preferably less than 7.5 wt. %, more preferably less than 5 wt. %, even more preferably less than 2.5 wt. %, most preferably less than 1 wt. % by total weight of the solid electrolyte mixture. In a more preferred embodiment the solid electrolyte mixture comprises less than 1000 ppm of a liquid by total weight of the solid electrolyte mixture, preferably less than 500 ppm, more preferably less than 100 ppm, even more preferably less than 50 ppm, most preferably less than 10 ppm by total weight of the solid electrolyte mixture.

The term “solid electrolyte” as used herein refers to an electrolyte being essentially free of any liquid. The term “essentially free of liquid” means that the solid electrolyte comprises less than 10 wt. % of a liquid by total weight of the solid electrolyte, preferably less than 7.5 wt. %, more preferably less than 5 wt. %, even more preferably less than 2.5 wt. %, most preferably less than 1 wt. % by total weight of the solid electrolyte. In a more preferred embodiment the solid electrolyte comprises less than 1000 ppm of a liquid by total weight of the solid electrolyte, preferably less than 500 ppm, more preferably less than 100 ppm, even more preferably less than 50 ppm, most preferably less than 10 ppm by total weight of the solid electrolyte.

### Solid Electrolyte

In a first aspect the invention provides a solid electrolyte having a composition according to formula (I)

Li_{6-y}PS_{5-y}BrX_{y} (I)

, wherein 0.0<y<0.8 and X is F, Cl, I or a combination thereof.

In preferred embodiments the solid electrolyte is according to the invention, wherein 0.01≤y≤0.79, preferably 0.05≤y≤0.75, more preferably 0.075≤y≤0.725, even more preferably 0.09≤y≤0.71, most preferably 0.1≤y≤0.7. In certain preferred embodiments the solid electrolyte is according to the invention, wherein 0.4≤y≤0.7, preferably 0.5≤y≤0.7, more preferably 0.55≤y≤0.65.

In certain preferred embodiments the solid electrolyte is according to the invention, wherein 0.01≤y≤0.59, preferably 0.05≤y≤0.55, more preferably 0.075≤y≤0.52, even more preferably 0.09≤y≤0.51, most preferably 0.1≤y≤0.5.

In certain preferred embodiments the solid electrolyte is according to the invention, wherein X is F, Cl, I or a combination thereof; preferably X is Cl, I or a combination thereof; preferably X is Cl.

In certain preferred embodiments the solid electrolyte is according to the invention, wherein X is F, Cl or I; preferably X is Cl or I; preferably X is Cl.

In accordance with preferred embodiments of the invention, the solid electrolyte is provided wherein at least 50 mol % of X represents Cl, preferably at least 80 mol % of X represents Cl, most preferably X represents Cl.

In accordance with preferred embodiments of the invention, the solid electrolyte is provided wherein X represents Cl, F, I or a combination thereof and wherein at least 50 mol % of X represents Cl, preferably at least 80 mol % of X represents Cl.

In accordance with preferred embodiments of the invention, the solid electrolyte is provided wherein at least 50 mol % of X represents F, preferably at least 80 mol % of X represents F, most preferably X represents F.

In accordance with preferred embodiments of the invention, the solid electrolyte is provided wherein X represents Cl, F, I or a combination thereof and wherein at least 50 mol % of X represents F, preferably at least 80 mol % of X represents F.

In accordance with preferred embodiments of the invention, the solid electrolyte is provided wherein at least 50 mol % of X represents I, preferably at least 80 mol % of X represents I, most preferably X represents I.

In accordance with preferred embodiments of the invention, the solid electrolyte is provided wherein X represents Cl, Br, I or a combination thereof and wherein at least 50 mol % of X represents I, preferably at least 80 mol % of X represents I.

In certain preferred embodiments the solid electrolyte is according to the invention, wherein
X is Cl, and
0.01≤y≤0.79, preferably 0.09≤y≤0.71, most preferably 0.1≤y≤0.7.

In certain preferred embodiments the solid electrolyte is according to the invention, wherein
X is Cl, and
0.4≤y≤0.7, preferably 0.5≤y≤0.7, most preferably 0.55≤y≤0.65.

In certain preferred embodiments the solid electrolyte is according to the invention, wherein
X is Cl, and
wherein 0.01≤y≤0.59, preferably 0.05≤y≤0.55, more preferably 0.075≤y≤0.52, even more preferably 0.09≤y≤0.51, most preferably 0.1≤y≤0.5.

In certain preferred embodiments the solid electrolyte is according to the invention, wherein
X is I, and
0.0<y<0.5, preferably 0.01≤y≤0.49, more preferably 0.05≤y≤0.45, even more preferably 0.09≤y≤0.41, most preferably 0.1≤y≤0.4.

In certain preferred embodiments the solid electrolyte is according to the invention, wherein
X is I, and
0.05≤y≤0.35, preferably 0.075≤y≤0.325, more preferably 0.1≤y≤0.3.

In more preferred embodiments the solid electrolyte is according to the invention, wherein the solid electrolyte is according to formula (I)a-g.

| | |
|---|---|
| Li_{5.9}PS_{4.9}BrCl_{0.1} | (I)a |
| Li_{5.8}PS_{4.8}BrCl_{0.2} | (I)b |
| Li_{5.7}PS_{4.7}BrCl_{0.3} | (I)c |
| Li_{5.6}PS_{4.6}BrCl_{0.4} | (I)d |
| Li_{5.5}PS_{4.5}BrCl_{0.5} | (I)e |
| Li_{5.4}PS_{4.4}BrCl_{0.6} | (I)f |
| Li_{5.3}PS_{4.3}BrCl_{0.7} | (I)g |

In preferred embodiments the solid electrolyte is according to the invention having a F-43m space group, preferably with a lattice parameter a (Å) between 10.00 and 9.90, preferably between 9.99 and 9.91, more preferably between 9.985 and 9.915, as determined by least square refinements of XRD profile and/or Rietveld analysis.

In preferred embodiments the solid electrolyte is according to the invention having an argyrodite-type crystal structure.

In preferred embodiments the solid electrolyte is according to the invention, wherein the molar ratios of Li:P:S:Br:X are between (5-6):(0.9-1.1):(4-5):(0.9-1.1):(0.01-0.79), preferably (5.1-5.9):(0.91-1.09):(4.1-4.9):(0.91-1.09):(0.05-0.75), more preferably (5.29-5.91):(0.99-1.01):(4.29-4.91):(0.99-1.01):(0.09-0.71), most preferably (5.3-5.9):1:(4.3-4.9):1:(0.1-0.7).

In preferred embodiments the solid electrolyte is according to the invention having a conductivity between 1 and 12 mS/cm, preferably between 2 and 10 mS/cm, most preferably between 6 and 10 mS/cm.

In certain preferred embodiments the solid electrolyte is according to the invention, wherein
X is Cl;
0.4≤y≤0.7, preferably 0.5≤y≤0.7, most preferably 0.55≤y≤0.65; and
the solid electrolyte having a conductivity between 5 and 12 mS·cm⁻¹, preferably between 5.5 and 11 mS·cm⁻¹, most preferably between 6 and 10 mS·cm⁻¹.

In certain preferred embodiments the solid electrolyte is according to the invention, wherein
the solid electrolyte is Li_{5.5}PS_{4.5}BrCl_{0.5}, and
the solid electrolyte having a conductivity between 0.1 mS·cm⁻¹ and 1.9 mS·cm⁻¹, preferably between 0.5 mS·cm⁻¹ and 1.5 mS·cm⁻¹, most preferably about 1 mS·cm⁻¹, wherein the conductivity is measured at −20° C.

In preferred embodiments the solid electrolyte is according to the invention having a purity of at least 90%, preferably at least 95%, more preferably at least 99%, as determined by XRD.

In preferred embodiments the solid electrolyte is according to the invention having a peak between 420 cm⁻¹ and 430 cm⁻¹, preferably between 421 cm⁻¹ and 429 cm⁻¹, most preferably between 422 cm⁻¹ and 428 cm⁻¹, as determined by Raman spectroscopy.

In preferred embodiments the solid electrolyte is according to the invention having a good moisture stability, in particular the solid electrolyte generated or released less than 5.0 mmol·L⁻¹·g⁻¹ H₂S after 15 minutes, preferably less than 4.5 mmol·L⁻¹·g⁻¹ H₂S after 15 minutes, more preferably less than 4.0 mmol·L⁻¹·g⁻¹ H₂S after 15 minutes, as determined via moisture stability.

### Method for Manufacturing

In a second aspect the invention provides a method for manufacturing a solid electrolyte comprising the following steps:
a) providing a solid electrolyte precursor mixture comprising Li₂S, P₂S₅, LiBr and LiX;
b) mixing of the solid electrolyte precursor mixture to obtain a solid electrolyte mixture; and
c) heat-treating of the solid electrolyte mixture to obtain a solid electrolyte; wherein X is an halogen selected from F, Cl, I or combinations thereof, preferably X is selected from Cl, I or combinations thereof, most preferably X is Cl.

In highly preferred embodiments the method is according to the invention, wherein the solid electrolyte is the solid electrolyte according to the first aspect of the invention.

As appreciated by the skilled person all embodiments related to the solid electrolyte according to first aspect of the invention equally apply to the method for manufacturing the solid electrolyte according to the invention.

In preferred embodiments the method is according to the invention, wherein the mixing of the solid electrolyte precursor of step b) is for at least 15 minutes, preferably at least 0.5 hour, most preferably at least 1 hour.

In preferred embodiments the method is according to the invention, wherein the mixing of the solid electrolyte precursor of step b) is between 1 hour and 60 hours, preferably between 5 hours and 45 hours, most preferably between 10 hours and 30 hours.

In preferred embodiments the method is according to the invention, wherein the mixing of the solid electrolyte precursor of step b) with a mixing speed of 100-1000 rpm, preferably a mixing speed of 300-900 rpm, most preferably a mixing speed of 400-800 rpm.

In preferred embodiments the method is according the invention, wherein the mixing of the solid electrolyte precursor mixture of step b) occurs at a temperature of at least 5° C., preferably at least 10° C., more preferably at least 15° C. A preferred embodiment is the method according to the invention, wherein the mixing of the solid electrolyte precursor mixture of step b) occurs at a temperature of less than 50° C., preferably less than 40° C., more preferably less than 30° C. A preferred embodiment is the method according to the invention, wherein the mixing of the solid electrolyte precursor mixture of step b) occurs at a temperature between 5 and 50° C., preferably a temperature between 1° and 40° C., more preferably a temperature between 15 and 30° C.

In certain preferred embodiments the method is according to the invention, wherein the mixing of the solid electrolyte precursor of step b)
with a mixing time between 1 hour and 60 hours, preferably between 5 hours and 45 hours, most preferably between 10 hours and 30 hours; and
with a mixing speed of 100-1000 rpm, preferably a mixing speed of 300-900 rpm, most preferably a mixing speed of 400-800 rpm.

In certain preferred embodiments the method is according to the invention wherein step b) comprises of
b1) mixing of the solid electrolyte precursor mixture to obtain a solid electrolyte pre-mixture
   with a mixing time between 1 minutes and 10 hours, preferably between 5 minutes and 5 hours, most preferably between 15 minutes and 3 hours; and
   with a mixing speed of 1-500 rpm, preferably a mixing speed of 50-300 rpm, most preferably a mixing speed of 100-200 rpm.
b2) mixing of the solid electrolyte pre-mixture to obtain a solid electrolyte mixture
   with a mixing time between 1 hour and 60 hours, preferably between 5 hours and 45 hours, most preferably between 10 hours and 30 hours; and
   with a mixing speed of 100-1000 rpm, preferably a mixing speed of 300-900 rpm, most preferably a mixing speed of 400-800 rpm.

In preferred embodiments the method is according to the invention, wherein the heat-treating of the solid electrolyte mixture of step c) occurs at a temperature of at least 100° C., preferably at least 200° C., more preferably at least 300° C., even more preferably at least 350° C., most preferably at least 400° C. In preferred embodiments the method is according to the invention, wherein the heat-treating of the solid electrolyte mixture of step c) occurs at a temperature of less than 1000° C., preferably less than 900° C., more preferably less than 750° C., even more preferably less than 600° C., most preferably less than 500° C. In preferred embodiments the method is according to the invention, wherein the heat-treating of the solid electrolyte mixture of step c) occurs at a temperature between 10° and 1000° C., preferably between 30° and 750° C., most preferably between 45° and 550° C.

In preferred embodiment the method is according to the invention, wherein the heat-treating of the solid electrolyte mixture of step c) is at least 1 min, preferably at least 0.5 hour, more preferably at least 1 hour, even more preferably at least 1.5 hours, most preferably at least 2 hours. In preferred embodiments the method is according to the invention, wherein the heat-treating of the solid electrolyte mixture of step c) is less than 48 hours, preferably less than 24 hours, more preferably less than 18 hours, even more preferably less than 12 hours, even more preferably less than 10 hours. In preferred embodiments the method is according to the invention, wherein the heat-treating of the solid electrolyte mixture of step c) is between 0.5 hour and 24 hours, preferably between 1 hours and 12 hours, more preferably between 1.5 hours and 10 hours.

In certain preferred embodiment the method is according to the invention, wherein the heat-treating of the solid electrolyte mixture of step c)
occurs at a temperature between 10° and 1000° C., preferably between 30° and 750° C., most preferably between 45° and 550° C.; and
is between 0.5 hour and 24 hours, preferably between 1 hours and 12 hours, most preferably between 1.5 hours and 10 hours.

### Composite Positive Electrode Active Material

A third aspect of the invention concerns a composite positive electrode active material comprising a positive electrode active material and the solid electrolyte according to the first aspect of the invention.

The term “a positive electrode active material” (also known as cathode active material) as used herein and in the claims is defined as a material which is electrochemically active in a positive electrode or cathode. By active material, it must be understood to be a material capable to capture and release Li ions when subjected to a voltage change over a predetermined period of time.

In a preferred embodiment the positive electrode active material (also known as cathode active material) comprises Li, M, and O, wherein M comprises Ni and one or both of Mn and Co. Preferably, the cathode active material comprises Li, M, and O, wherein M comprises
Ni in a content x, wherein 50.0 mol %≤x≤95.0 mol %, relative to M;
Mn in a content y, wherein 0.0 mol %≤y≤40.0 mol %, relative to M;
Co in a content z, wherein 0.0 mol %≤z≤40.0 mol %, relative to M;
D in a content a, wherein 0.0 mol %≤a≤2.0 mol %, relative to M, wherein D is at least one element other than Li, Ni, Mn, Co, and 0;
wherein x+y+z+a is 100.0 mol %;
   more preferably wherein M comprises:
Ni in a content x, wherein 55.0 mol %≤x≤85.0 mol %, relative to M;
Mn in a content y, wherein 10.0 mol %≤y≤30.0 mol %, relative to M;
Co in a content z, wherein 10.0 mol %≤z≤30.0 mol %, relative to M;
D in a content a, wherein 0.0 mol %≤a≤2.0 mol %, relative to M, wherein D is at least one element other than Li, Ni, Mn, Co, and 0;
wherein x+y+z+a is 100.0 mol %;
   most preferably wherein M comprises:
Ni in a content x, wherein 58.0 mol %≤x≤70.0 mol %, relative to M;
Mn in a content y, wherein 15.0 mol %≤y≤25.0 mol %, relative to M;
Co in a content z, wherein 15.0 mol %≤z≤25.0 mol %, relative to M;
D in a content a, wherein 0.0 mol %≤a≤2.0 mol %, relative to M, wherein D is at least one element other than Li, Ni, Mn, Co, and 0;
wherein x+y+z+a is 100.0 mol %.

In some particularly preferred embodiments, x is about 60 mol %, y is about 20 mol % and z is about 20 mol %. This is also known as NMC 622.

In preferred embodiments of the invention D is at least one element selected from the group consisting of Al, Ti, B, Ba, Ca, Cr, Fe, Mg, Mo, Nb, S, Si, Sr, V, W, Y, Zn, and Zr; preferably Al, B, Ti, Cr, Nb, S, Si, Y, Zr and W; more preferably Al, B, Ti, Nb, Zr and W.

In some particularly preferred embodiments a=0.0 mol %.

In a preferred embodiment the Li/M ratio (mol/mol) is between 0.9 and 1.1, preferably between 0.95 and 1.05, more preferably between 0.99 and 1.01, most preferably about 1.

As appreciated by the skilled person the amount of Li and M, preferably Li, Ni, Mn and Co in the positive electrode active material is measured by Inductively Coupled Plasma Optical Emission Spectroscopy (ICP-OES). For example, but not limiting to the invention, an Agilent ICP 720-ES is used in the ICP-OES analysis.

In certain preferred embodiments the solid electrolyte is according to formula (I), wherein 0.4≤y≤0.7, preferably 0.5≤y≤0.7, more preferably 0.55≤y≤0.65. In certain preferred embodiments the solid electrolyte is according to formula (I)f.

In certain preferred embodiments the solid electrolyte is according to formula (I), wherein 0.01≤y≤0.59, preferably 0.05≤y≤0.55, more preferably 0.075≤y≤0.52, even more preferably 0.09≤y≤0.51, most preferably 0.1≤y≤0.5.

In preferred embodiments the composite positive electrode active material comprises
the positive electrode active material between 55 and 95 wt. % by total weight of the composite positive electrode active material, preferably between 65 and 85 wt. %, more preferably between 65 and 75 wt. % by total weight of the composite positive electrode active material; and
the solid electrolyte according to the first aspect of the invention between 5 and 55 wt. % by total weight of the composite positive electrode active material preferably between 15 and 35 wt. %, more preferably between 25 and 35 wt. % by total weight of the composite positive electrode active material.

In highly preferred embodiments the composite positive electrode active material of the invention comprises the positive electrode active material as defined herein and the solid electrolyte according to the first aspect of the invention,
wherein the positive electrode active material comprises Li, M, and O, wherein M comprises:
   Ni in a content x, wherein 58.0 mol %≤x≤70.0 mol %, relative to M;
   Mn in a content y, wherein 15.0 mol %≤y≤25.0 mol %, relative to M;
   Co in a content z, wherein 15.0 mol %≤z≤25.0 mol %, relative to M;
   D in a content a, wherein 0.0 mol %≤a≤2.0 mol %, relative to M, wherein D is at least one element other than Li, Ni, Mn, Co, and 0;
   wherein x+y+z+a is 100.0 mol %, and
wherein the solid electrolyte is according to formula (I), wherein 0.4 s y s 0.7, preferably 0.5≤y≤0.7, more preferably 0.55≤y≤0.65.

In highly preferred embodiments the composite positive electrode active material of the invention comprises the positive electrode active material as defined herein and the solid electrolyte according to the first aspect of the invention, wherein the positive electrode active material comprises Li, M, and O, wherein M comprises:
Ni in a content x=60 mol %, relative to M;
Mn in a content y=20 mol %, relative to M;
Co in a content z=20 mol %, relative to M; and
   wherein the solid electrolyte is according to formula (I)f.

### Battery

A fourth aspect of the invention concerns a battery comprising a negative electrode, a positive electrode and a solid electrolyte layer, wherein at least one of the cathode, the anode and the solid electrolyte layer comprises the solid electrolyte according to the invention. The present solid electrolyte of the invention can be used as a solid electrolyte layer of a solid lithium ion battery or a solid lithium primary cell, or as a solid electrolyte that is mixed with an electrode mixture for a positive electrode or a negative electrode.

In a preferred embodiment the battery is a solid-state battery, preferably a lithium solid-state battery.

As appreciated by the skilled person a negative electrode is an anode and a positive electrode is a cathode. Hence, the present invention concerns a battery comprising a negative electrode, a positive electrode and a solid electrolyte layer, wherein at least one of the positive electrode, the negative electrode and the solid electrolyte layer comprises the solid sulfide electrolyte according to the invention.

As appreciated by the skilled person the solid electrolyte layer is a separator layer or a membrane layer separating the anode and the cathode from one another. A certain preferred embodiment is the battery according to the invention, wherein the positive electrode comprises the composite positive electrode active material according to the third aspect of the invention.

A certain preferred embodiment is the battery according to the invention, wherein the positive electrode comprises a further positive electrode active material comprising Li, M′, and O and the solid electrolyte layer comprises the solid electrolyte according to the first aspect of the invention.

As appreciated the positive electrode as defined herein may comprise the composite positive electrode active material according to the third aspect of the invention and/or may comprise the further positive electrode active material as defined herein but may additionally comprise other components, which are not electrochemically active, in particular conductivity agents such as carbon black or binders such as PVDF.

The further positive electrode active material comprises Li, M′ and O, wherein M′ comprises Ni and one or both of Mn and Co. Preferably, the positive active material comprises Li, M′, and O, wherein M′ comprises
Ni in a content x′, wherein 50.0 mol %≤x′≤95.0 mol %, relative to M′;
Mn in a content y′, wherein 0.0 mol %≤y′≤40.0 mol %, relative to M′;
Co in a content z′, wherein 0.0 mol %≤z′≤40.0 mol %, relative to M′;
D′ in a content a′, wherein 0.0 mol %≤a′≤2.0 mol %, relative to M′, wherein D′ is at least one element other than Li, Ni, Mn, Co, and 0;
wherein x′+y′+z′+a′ is 100.0 mol %;
   more preferably wherein M′ comprises:
Ni in a content x′, wherein 55.0 mol %≤x′≤85.0 mol %, relative to M′;
Mn in a content y′, wherein 10.0 mol %≤y′≤30.0 mol %, relative to M′;
Co in a content z′, wherein 10.0 mol %≤z′≤30.0 mol %, relative to M′;
D′ in a content a′, wherein 0.0 mol %≤a′≤2.0 mol %, relative to M′, wherein D′ is at least one element other than Li, Ni, Mn, Co, and 0;
wherein x′+y′+z′+a′ is 100.0 mol %;
   most preferably wherein M′ comprises:
Ni in a content x′, wherein 58.0 mol %≤x′≤70.0 mol %, relative to M′;
Mn in a content y′, wherein 15.0 mol %≤y′≤25.0 mol %, relative to M′;
Co in a content z′, wherein 15.0 mol %≤z′≤25.0 mol %, relative to M′;
D′ in a content a′, wherein 0.0 mol %≤a′≤2.0 mol %, relative to M′, wherein D′ is at least one element other than Li, Ni, Mn, Co, and 0;
wherein x′+y′+z′+a′ is 100.0 mol %.

In preferred embodiments of the invention D′ is at least one element selected from the group consisting of Al, Ti, B, Ba, Ca, Cr, Fe, Mg, Mo, Nb, S, Si, Sr, V, W, Y, Zn, and Zr; preferably Al, B, Ti, Cr, Nb, S, Si, Y, Zr and W; more preferably Al, B, Ti, Nb, Zr and W.

In some particularly preferred embodiments a′=0.0 mol %.

In some particularly preferred embodiments, x′ is about 60 mol %, y′ is about 20 mol % and z′ is about 20 mol %. This is also known as NMC 622.

In a preferred embodiment the Li/M′ ratio (mol/mol) is between 0.9 and 1.1, preferably between 0.95 and 1.05, more preferably between 0.99 and 1.01, most preferably about 1.

As appreciated by the skilled person the amount of Li and M′, preferably Li, Ni, Mn and Co in the further positive electrode active material is measured by Inductively Coupled Plasma Optical Emission Spectroscopy (ICP-OES). For example, but not limiting to the invention, an Agilent ICP 720-ES is used in the ICP-OES analysis.

In a certain preferred embodiment the solid electrolyte layer comprises the solid electrolyte according to the first aspect of the invention. More preferably, the solid electrolyte layer consists of the solid electrolyte according to the first aspect of the invention.

In a certain preferred embodiment the solid electrolyte layer comprises a further solid electrolyte having a composition different from the solid electrolyte according to the first aspect of the invention. Preferably, the further solid electrolyte having a composition different from the solid electrolyte according to the invention is a sulfide solid electrolyte, more preferably the further solid electrolyte having a composition different from the solid electrolyte of the invention comprises Li, P and S. Typically, the following sulfur-containing compounds Li₆PS₅X with X=Cl, Br, I or a combination thereof, thio-LISICON (Li_{3.25}Ge_{0.25}P_{0.75}S₄), Li₂S—P₂S₅—LiCl, Li₂S—SiS₂, LiI—Li₂S—SiS₂, Li₂S—P₂S₅—LiCl, Li₂S—SiS₂, LiI—Li₂S—SiS₂, LiI—Li₂S—P₂S₅, LiI—Li₂S—P₂O₅, LiI—Li₃PO₄—P₂S₅, Li₂S—P₂S₅, Li₃PS₄, Li₇P₃S₁₁, LiI—Li₂S—B2S₃, Li₃PO₄—Li₂S—SiS₂, Li₃PO₄—Li₂S—SiS₂, Li₃PO₄—Li₂S—SiS₂, Li₁₀GeP₂S₁₂, Li_{9.54}Si_{1.74}P_{1.44}S_{11.7}Cl_{0.3}, and/or Li₇P₃S₁₁ may be suitable used. Even more preferably the further solid electrolyte having a composition different from the solid electrolyte according to the invention is an argyrodite-type solid electrolyte, most preferably Li₆PS₅Cl.

Thus, in a certain preferred embodiment is the battery according to the invention, wherein
the positive electrode comprises the composite positive electrode active material as defined herein, and
the solid electrolyte layer comprises the solid electrolyte according to the first aspect of the invention.

In another certain preferred embodiment is the battery according to the invention, wherein
the positive electrode comprises the composite positive electrode active material as defined herein; and
the solid electrolyte layer comprises the further solid electrolyte having a composition different from the solid electrolyte to the first aspect of the invention.

In another certain preferred embodiment is the battery according to the invention, wherein
the positive electrode comprises the further positive electrode active material comprising Li, M′, and O as defined herein and the further solid electrolyte having a composition different from the solid electrolyte as defined herein; and
the solid electrolyte layer comprises the solid electrolyte according to the first aspect of the invention.

In a certain highly preferred embodiment is the battery according to the invention, wherein
the positive electrode comprises the positive electrode active material comprising Li, M, and O, wherein M comprises:
   Ni in a content x, wherein 58.0 mol %≤x≤70.0 mol %, relative to M;
   Mn in a content y, wherein 15.0 mol %≤y≤25.0 mol %, relative to M;
   Co in a content z, wherein 15.0 mol %≤z≤25.0 mol %, relative to M;
   D in a content a, wherein 0.0 mol %≤a≤2.0 mol %, relative to M, wherein D is at least one element other than Li, Ni, Mn, Co, and 0;
   wherein x+y+z+a is 100.0 mol %, and
comprises the solid electrolyte is according to formula (I), wherein 0.4≤y≤0.7, preferably 0.5≤y s 0.7, more preferably 0.55≤y≤0.65; and
the solid electrolyte layer comprises the solid electrolyte according to formula (I), wherein 0.4≤y≤0.7, preferably 0.5≤y≤0.7, more preferably 0.55≤y≤0.65.

In a more certain highly preferred embodiment is the battery according to the invention, wherein
the positive electrode comprises the positive electrode active material comprising Li, M, and O, wherein M comprises:
   Ni in a content x=60 mol %, relative to M;
   Mn in a content y=20 mol %, relative to M;
   Co in a content z=20 mol %, relative to M; and comprises the solid electrolyte according to formula (I)f; and
wherein the solid electrolyte layer comprises the solid electrolyte is according to formula (I)f.

In a preferred embodiment the negative electrode comprises a negative electrode active material. Suitable electrochemically active negative electrode materials are those known in the art. For example, the anode may comprise graphitic carbon, metallic lithium or a metal alloy comprising lithium, such as Li—In alloy, as the negative electrode active material. Preferably, the negative electrode further comprises the solid sulfide electrolyte according to the first aspect of the invention and/or the further solid electrolyte having a composition different from the solid electrolyte to the first aspect of the invention as defined herein. Preferably the further solid electrolyte having a composition different from the solid electrolyte according to the invention is a sulfide solid electrolyte, more preferably the further solid electrolyte having a composition different from the solid electrolyte of the invention comprises Li, P and S, even more preferably the further solid electrolyte having a composition different from the solid electrolyte according to the invention is an argyrodite-type solid electrolyte, most preferably the further solid electrolyte having a composition different from the solid electrolyte according to the invention is an argyrodite-type solid electrolyte is Li₆PS₅Cl.

In a preferred embodiment the battery of the invention has a discharge capacity of at least 150 mAh/g, preferably at least 155 mAh/g, more preferably at least 160 mAh/g. As appreciated by the skilled person the discharge capacity is obtained at a C-rate of C/30 at room temperature within the voltage range of 1.9-3.6 V versus the LiIn/In reference electrode.

### Method for Manufacturing a Battery

A fifth aspect of the invention concerns a method for manufacturing a battery, preferably the battery according to the fourth aspect of the invention, comprising the following steps:
(a) providing a positive electrode, preferably the positive electrode as defined herein,
(b) providing a negative electrode, preferably the negative electrode as defined herein,
(c) providing the solid electrolyte layer as defined herein,
(d) forming the battery by assembling the positive electrode, the negative electrode, and the solid electrolyte layer into a battery.

A preferred embodiment is the method for manufacturing the battery, wherein step (d) comprises forming the battery by pressing the positive electrode, the negative electrode, and the solid electrolyte layer between 300 and 400 MPa, preferably around 375 MPa, for between 1 and 30 minutes, preferably about 5 minutes.

As appreciated by the skilled person all embodiments directed to the battery according to the fourth aspect of the invention apply mutatis mutandis to the method for manufacturing said battery. For example, the various embodiments relating to the composition of the cathode, anode and solid electrolyte layer as explained herein in the context of the battery are equally applicable to the method for manufacturing said battery.

### Use

A sixth aspect of the invention concerns a use of the solid electrolyte according to the invention in a battery, preferably a solid-state-battery, most preferably a lithium solid-state-battery.

A seventh aspect of the present invention concerns a use of the battery according to the invention in either one of a portable computer, a tablet, a mobile phone, an energy storage system, an electric vehicle or in a hybrid electric vehicle, preferably in an electric vehicle or in a hybrid electric vehicle.

The invention is further illustrated in the following examples:

### Examples

### Description of Testing Methods

### Synthesis Protocol

All the synthesis work and sample treatment were carried out in an Ar filled glovebox with O₂ and H₂O levels <0.1 ppm. For each example stoichiometric ratios of reagents, Li₂S (Sigma Aldrich, 99.98%), P₂S₅ (Sigma Aldrich, 99%), LiBr (Alfa Aesar, 99%), and LiCl (Alfa Aesar, 99%) were mixed to obtain a 2 g batch of precursors. The precursors were transferred into a Fritsch Pulverisette 7 premium line 80 mL zirconia ball-milling jar along with 20 zirconia balls of 10 mm diameter (the ball:powder ratio was 30:1 in mass). The precursors were initially milled at 150 rpm for 30 minutes to homogenize the mixture followed by ball milling at 600 rpm for a total duration of 20 hours. Each cycle constituted in 15-minute milling and 10-minute rest and reversing the direction of milling for every cycle. After every 8 hours of milling, the ball-milling jars were opened in the glovebox to scrape the material adhered to the cap and inside the surface of the jar. At the end of the ball milling step, approximately 90 wt % of the material was recovered. The ball-milled powder was uniaxially pressed into a 10 mm pellet and placed in pre-dried quartz tubes which were then flame-sealed under vacuum (10⁻² mbar) and placed in a furnace (Nabertherm) for annealing. The temperature of the furnace was slowly increased to 450° C. at a ramp rate of 1.5° C./min, held for 5 hours, and naturally cooled to room temperature. The reacted pellets were then pulverized using a pestle and mortar and stored in the glovebox for further analysis.

### X-Ray Diffraction

The powder X-ray diffraction patterns were collected using Bruker D8 diffractometers equipped with either Cu (Kα1-Kα2) or Mo (Kα1-Kα2) radiation in a θ-θ configuration. An air-tight sample holder with a Be window was used for the measurements. The patterns were collected between 2θ=10°-50° with a step size of 0.02°. The Fullproof suite was used to perform profile matching using the Le Bail method to determine the lattice parameters of the samples.

### Raman Spectroscopy

The spectra were collected using a Raman DXR Microscope (Thermo Fischer Scientific) equipped with a green laser of excitation wavelength of 532 nm. Laser power of 0.1 mW was used to avoid sample damage due to excessive local heating. Spectra were collected by 1 second exposure time and 180 exposures.

### Ionic Conductivity

About 200 mg of sample was uniaxially cold-pressed in a 10 mm die at 625 MPa. The relative density of the pellet was 85 to 87% and the thickness was 1.4 mm approximately. Indium foils were pressed on the surface of pellets as ion-blocking electrodes. AC impedance spectroscopy was performed on these pellets by mounting them in BioLogic CESH cell and spectra were recorded using MTZ 35 frequency response analyzer by applying 50 mV AC perturbation in the frequency range from 30 MHz to 1 Hz. Spectra were collected between the temperature of range of −20 to 50° C. with 10° C. intervals in the ITS temperature controller. The AC impedance data were analyzed using Zview or RelaxIS software.

### Moisture Stability

All the measurements were carried out on the same day to avoid the changes in humidity in ambient air. H₂S sensing experiments were performed in the following set up: approximately 45 mg of powder was pelletized in 10 mm die and these pellets were used for the measurement. To start the measurement, the pellet was placed on a rectangular polymer container in a desiccator, and the lid of the desiccator was closed. H₂S value in ppm was recorded every 20 seconds for 20 minutes with a H₂S sensor (model-INS—H2S-03 (0-400 ppm, 20-90% RH)). The number of moles of H₂S generated per liter of ambient air and gram of sample were calculated using the following equations:

$$1 {ppm}_{H 2 S} = \frac{1 {Liter}_{H 2 S} * {10}^{- 6}}{1 {Liter}_{air}}$$

The right side is multiplied by 10 as the desiccator has a volume of 10 L. Assuming that H₂S behaves like an ideal gas, we divided both sides by Vₘ, which is the molar volume of ideal gas at 1 bar and RT (24.79 L·mol⁻¹):

$$\frac{1 {ppm}_{H 2 S}}{24.79} = \frac{1 {mol}_{H 2 S} * {10}^{- 5}}{1 {Liter}_{air}} as \frac{1 {Liter}_{H 2 S}}{{V}_{m}} = 1 {mol}_{H 2 S}$$

Normalizing both sides with respect to the weight of the sample (mₛₐₘₚₗₑ) leads to:

$$\frac{1 {ppm}_{H 2 S}}{{m}_{sample} * 24.79} = \frac{1 {mol}_{H 2 S} * {10}^{- 5}}{1 {Liter}_{air} * 1 {g}_{sample}}$$

Using this formula, the number of moles of H₂S generated per 1 L of air and 1 g of sample was plotted as a function of time, which is useful for designing the production and the assembly stages in larger scales. Further, the reactivities of S atoms in each material in the presence of moisture is compared. To this end, the number moles of H₂S generated per 1 L of air and 1 mol of sample after 15 minutes of exposure is calculated using the equation below:

$$\frac{1 {ppm}_{H 2 S} * {MM}_{sample}}{{m}_{sample} * 24.79} = \frac{{mol}_{H 2 S} * {10}^{- 5}}{1 {Liter}_{air} * 1 {mol}_{sample}}$$

in which MMₛₐₘₚₗₑ is the molar mass of the sample (assuming that 100% purity) in g·mol⁻¹.

### Examples

### Synthesis of Solid Electrolytes

Table 1 displays the overall formula of the examples synthesized via the general synthesis protocol described above with their corresponding ionic conductivity. It is also observed noted that EX6 displays an ionic conductivity of 1 mS·cm⁻¹ even at −20° C., which makes it a very interesting composition for low-temperature applications.

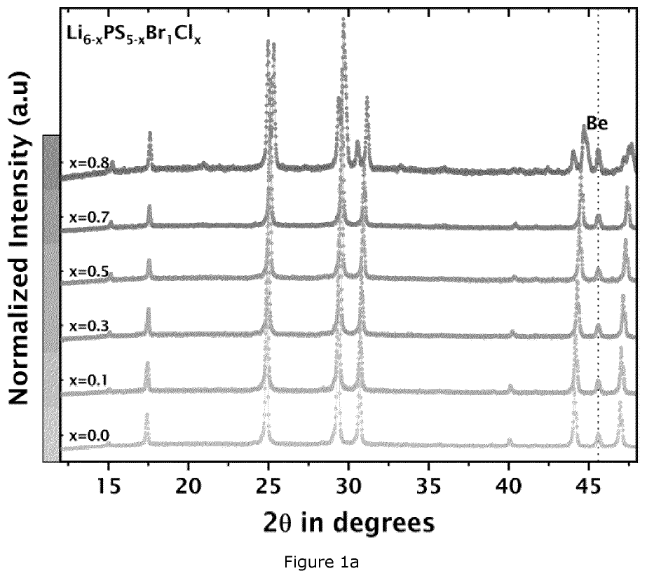

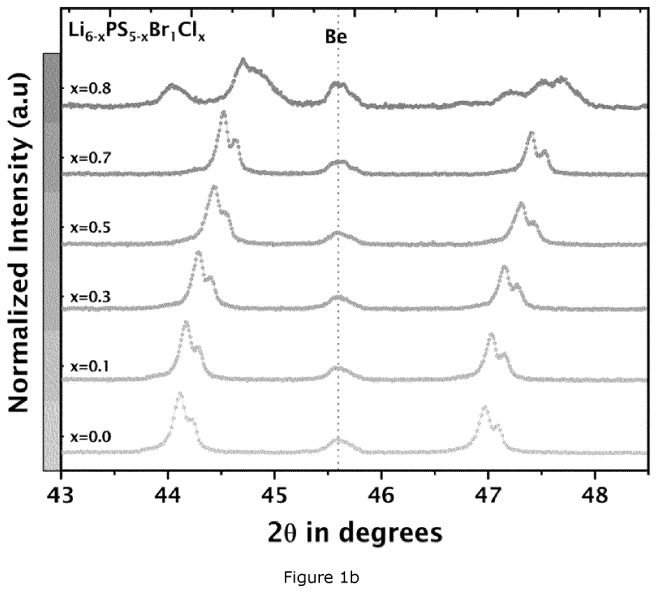

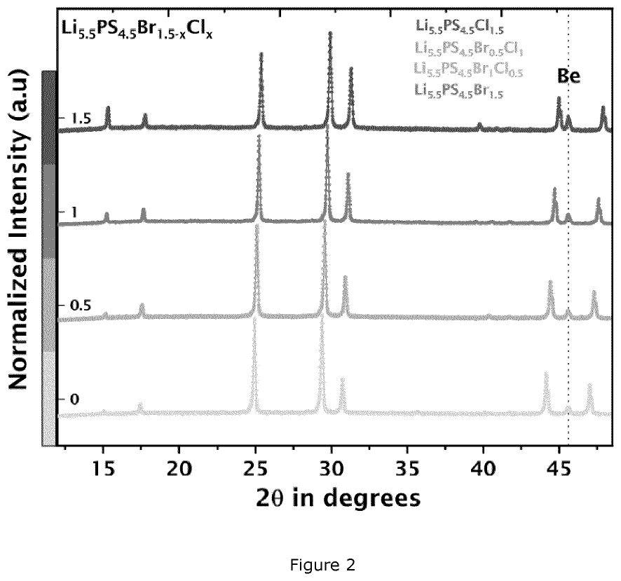

Profile matching of powder X-ray diffraction data suggest that the argyrodite structure is preserved for EX1-7 (space group: F4-3m). No peaks corresponding to the precursors or other impurity phases are observed except for the peak at 2θ=45.6 0 from Be-containing sample holder. Further increase of CI-content (CEX5) results in the formation of additional impurities (see FIG. 1a and FIG. 1b). Powder diffraction patterns, as shown in FIG. 2, confirm the successful synthesis of CEX1-3 and EX5 without any impurities.

TABLE 1
Overall formula and ionic conductivities of CEX1-4 and EX1-7.

| | | Ionic |
|---|---|---|
| | | Conductivity at |
| Examples | Formula | 25° C. (mS · cm⁻¹) |
| CEX1 | Li_{5.5}PS_{4.5}ClBr_{0.5} | 9.9 |
| CEX2 | Li_{5.5}PS_{4.5}Cl_{1.5} | 8.5 |
| CEX3 | Li_{5.5}PS_{4.5}Br_{1.5} | 5.6 |
| CEX4 | Li₆PS₅Br | 1.2 |
| EX1 | Li_{5.9}PS_{4.9}BrCl_{0.1} | 2.0 |
| EX2 | Li_{5.8}PS_{4.8}BrCl_{0.2} | 3.1 |
| EX3 | Li_{5.7}PS_{4.7}BrCl_{0.3} | 5.1 |
| EX4 | Li_{5.6}PS_{4.6}BrCl_{0.4} | 6.4 |
| EX5 | Li_{5.5}PS_{4.5}BrCl_{0.5} | 8.8 |
| EX6 | Li_{5.4}PS_{4.4}BrCl_{0.6} | 9.9 |
| EX7 | Li_{5.3}PS_{4.3}BrCl_{0.7} | 8.1 |
| CEX5 | Li_{5.2}PS_{4.2}BrCl_{0.8} | 0.7 |

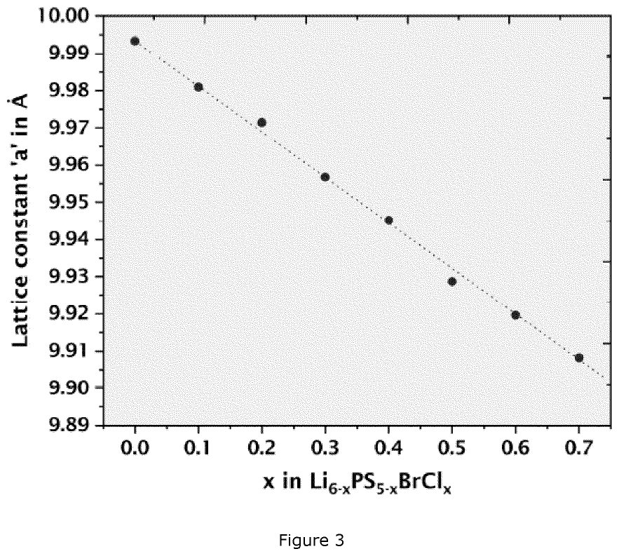

The calculated lattice parameter values, which are obtained by performing profile matching using the Le Bail method, in fullproof suite, gathered in FIG. 3 indicate the linear variation with x in lattice constant values that follows Vegard's law, and confirm the successful preparation of EX1-7. When increasing the Cl⁻-content, it is shown that the cubic lattice parameter a gradually decreases from 9.993 Å for CEX4 to 9.908 Å for EX7 as shown in FIG. 3.

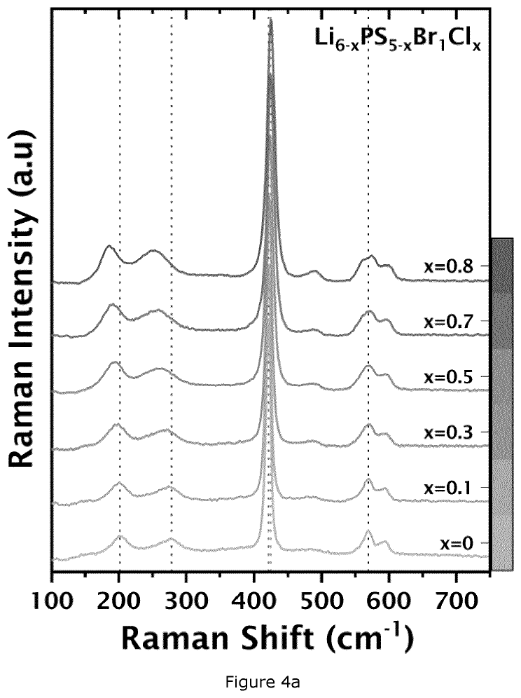

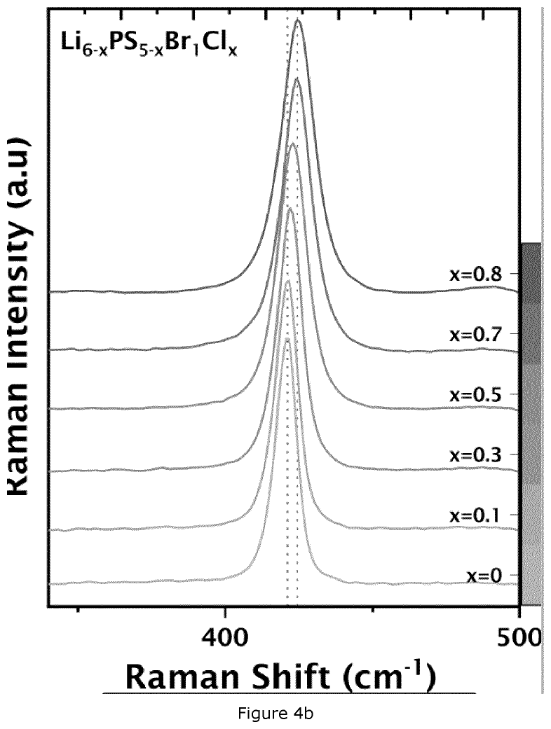

Raman spectroscopy was carried out to further confirm the effect of Cl⁻ substitution on the structure of EX1-7 and CEX5. As shown in FIGS. 4a and 4b, Raman spectra of all the samples show a sharp peak at 421 cm⁻¹ (v_{sym}) accompanied by other prominent peaks at ˜200, 268, 568, and 593 cm⁻¹ all corresponding to different normal modes of PS4 tetrahedron. With increasing Cl⁻ content, the position of the symmetric stretching mode (v_{sym}) at 421 cm⁻¹ is gradually shifting towards a higher wavenumber (see FIGS. 4a and 4b).

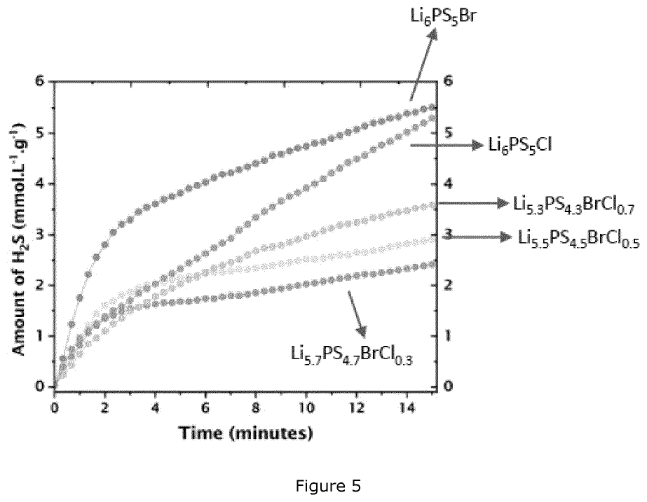

H₂S evolution measurements of all the samples were measured on the same day to maintain the relative humidity constant. FIG. 5 shows the quantity of H₂S evolved over 15 minutes for EX3, EX5 and EX7 versus CEX4 and commercially available argyrodite Li₆PS₅Cl. As shown in FIG. 5, it is evident that H₂S evolution is considerably lesser of EX3, EX5 and EX7 when compared to commercially available Li₆PS₅Cl and CEX4.

### Battery Assembly

### 1) Preparation of Cathode Composite:

The cathode composite was prepared by manually grinding 70 wt % NMC-622 and 30 wt % solid electrolyte in an agate mortar and pestle for 20 minutes. No additional conducting carbons were added to the composite.

### 2) Anode Composite:

The anode composite was prepared by manually grinding 60:40 weight ratio of Li_{0.5}In alloy and Li₆PS₅Cl for 1 hour until dark grey powder is obtained.

### 3) Battery Assembly:

Battery assembly and electrochemical testing were conducted using a PMMA (Polymethyl methacrylate) matrix and two stainless steel pistons with a diameter of 10 mm. All assembling procedures were carried out under an argon atmosphere in a glovebox ([O₂]<1 ppm, [H₂O]<1 ppm).

The cell was assembled as follows:
a. Around 49 mg of solid electrolyte was added into the PMMA matrix and cold-pressed at 125 MPa under a hydraulic press for 1 minute.
b. On one side of the solid electrolyte, 20 to 22 mg of the cathode composite was evenly spread (NMC loading: 14 to 15 mg).
c. On the other side of the solid electrolyte, 85 mg of the anode composite was evenly spread.
d. The entire stack was compressed at 375 MPa for 5 minutes.
e. The cell was transferred to a stainless-steel frame, and a uniaxial stack pressure of 100 MPa was applied using a torque key.
f. The entire setup was then transferred to a hermetic glass jar for further electrochemical testing.

### Electrochemical Cycling Protocols:

Galvanostatic cycling studies were conducted at room temperature within the potential range of 1.9-3.6 V versus the LiIn/In reference electrode. The First charge-discharge cycle was performed at a C-rate of C/30. (C corresponds to 0.6 mol of Li per mole of the active material in 1 h). This is followed by cycling at different C rates, including C/15, C/10, C/5, C/2, and 1C. Each C rate was repeated for a total of 6 cycles. For the assessment of long cycling stability, the cell was subjected to continuous cycling at a C/5 rate for 50 cycles.

### Results

Table 2 displays the specific capacity and retention of the battery comprising the cathode composite being NMC622 and Li_{5.4}PS_{4.4}BrCl_{0.6} and the solid electrolyte layer being Li_{5.4}PS_{4.4}BrCl_{0.6} (EX8) and a battery comprising the cathode composite being NMC622 and Li₆PS₅Cl and the solid electrolyte being Li₆PS₅Cl (CEX6).

TABLE 2
specific capacity and retention for EX8 and CEX6

| | EX8 | CEX6 |
|---|---|---|
| Charge capacity (mAh/g) | 180.8 | 163. |
| Discharge capacity (mAh/g) | 163.3 | 146.1 |
| Retention | 90.3% | 89.4% |

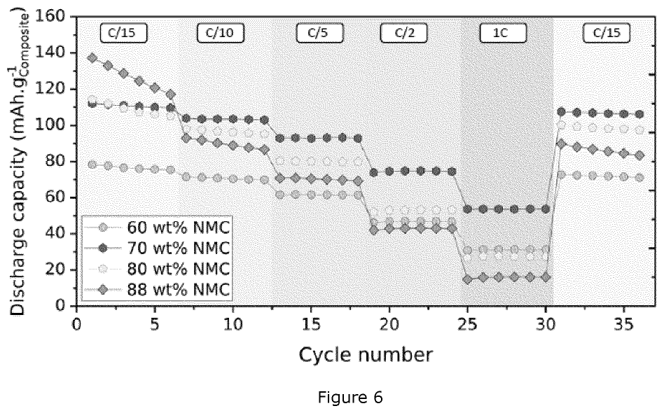

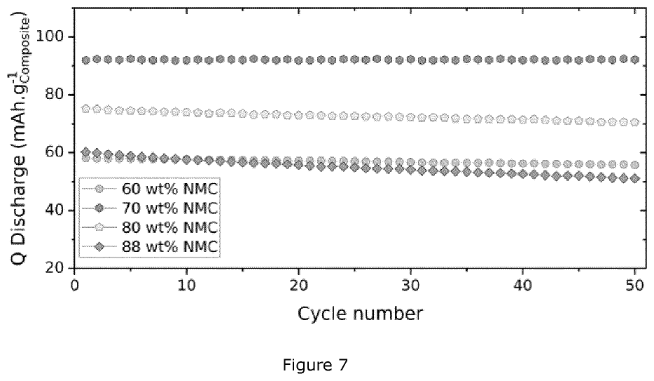

FIGS. 6 and 7 display the rate capability and long cycling stability for batteries comprising a cathode composite comprising different wt. % of NMC-622 and Li_{5.4}PS_{4.4}BrCl_{0.6}. In these batteries the solid electrolyte layer is also Li_{5.4}PS_{4.4}BrCl_{0.6}.

1-20. (canceled)

21. A solid electrolyte having a composition according to formula (I)
Li_{6-y}PS_{5-y}BrX_{y} (I),
wherein 0.0<y<0.8 and X is F, Cl, I or a combination thereof.

22. The solid electrolyte according to claim 21, wherein 0.05≤y≤0.75.

23. The solid electrolyte according to claim 21, wherein X is F, Cl, or I.

24. The solid electrolyte according to claim 21, wherein 0.4≤y≤0.7.

25. The solid electrolyte according to claim 21, wherein 0.01≤y≤0.59.

26. The solid electrolyte according to claim 21, wherein X is Cl and 0.1≤y≤0.7.

27. The solid electrolyte according to claim 21, wherein X is I and 0.0≤y≤0.4.

28. The solid electrolyte according to claim 27, wherein 0.05≤y≤0.35.

29. The solid electrolyte according to claim 21 having a composition according to formula (I)a-g:

| | |
|---|---|
| Li_{5.9}PS_{4.9}BrCl_{0.1} | (I)a |
| Li_{5.8}PS_{4.8}BrCl_{0.2} | (I)b |
| Li_{5.7}PS_{4.7}BrCl_{0.3} | (I)c |
| Li_{5.6}PS_{4.6}BrCl_{0.4} | (I)d |
| Li_{5.5}PS_{4.5}BrCl_{0.5} | (I)e |
| Li_{5.4}PS_{4.4}BrCl_{0.6} | (I)f |
| Li_{5.3}PS_{4.3}BrCl_{0.7} | (I)g |

30. The solid electrolyte according to claim 21 having an F-43m space group, as determined by Rietveld analysis.

31. The solid electrolyte according to claim 21 having an ionic conductivity between 1 and 12 mS/cm.

32. The solid electrolyte according to claim 21 having a purity of at least 90%, as determined by XRD.

33. The solid electrolyte according to claim 21 generated less than 5.0 mmol·L⁻¹·g⁻¹ H₂S after 15 minutes as determined via moisture stability.

34. A method for manufacturing a solid electrolyte, comprising the following steps:
a) providing a solid electrolyte precursor mixture comprising Li₂S, P₂S₅, LiBr and LiX;
b) mixing of the solid electrolyte precursor mixture to obtain a solid electrolyte mixture; and
c) heat-treating of the solid electrolyte mixture to obtain a solid electrolyte;
wherein X is a halogen selected from F, Cl, I, or combinations thereof.

35. The method according to claim 34, wherein the mixing of the solid electrolyte precursor of step b) is for at least 0.5 hour.

36. A composite positive electrode active material comprising a positive electrode active material and the solid electrolyte according to claim 21, wherein the positive electrode active material comprises Li, M, and O, wherein M comprises Ni and one or both of Mn and Co.

37. The composite positive electrode active material according to claim 36, wherein M comprises
Ni in a content x, wherein 50.0 mol %≤x≤95.0 mol %, relative to M;
Mn in a content y, wherein 0.0 mol %≤y≤40.0 mol %, relative to M;
Co in a content z, wherein 0.0 mol %≤z≤40.0 mol %, relative to M; and
D in a content a, wherein 0.0 mol %≤a≤2.0 mol %, relative to M, wherein D is at least one element other than Li, Ni, Mn, Co, and 0;
wherein x+y+z+a is 100.0 mol %.

38. A battery comprising a negative electrode, a positive electrode, and a solid electrolyte layer, wherein at least one of the positive electrode, the negative electrode, and the solid electrolyte layer comprises the solid electrolyte according to claim 21.

39. Battery, according to claim 38, wherein the positive electrode comprises the composite positive electrode active material according to claim 36.

40. Battery according to claim 38, wherein the solid electrolyte layer comprises the solid electrolyte according to claim 21.
